(19) United States
(12) Patent Application Publication
(10) Pub. No.: US 2011/0320589 A1
(43) Pub. Date: Dec. 29, 2011

(54) METHOD AND DEVICE FOR PROCESSING DATA IN A NETWORK

(75) Inventor: Erkki Juhani Hietala, Espoo (FI)

(73) Assignee: NOKIA SIEMENS NETWORKS OY, ESPOO (FI)

(21) Appl. No.: 13/141,880

(22) PCT Filed: Dec. 23, 2009
(86) PCT No.: PCT/EP2009/067829

§ 371 Date: Sep. 12, 2011

(30) Foreign Application Priority Data
Dec. 23, 2008 (EP) 08106030.3

(51) Int. Cl. G06F 15/16; G06F 15/173

(52) U.S. Cl. 709/224; 709/246; 709/239

(57) ABSTRACT

A method and a device for processing data in a network are provided. The method includes using a gateway for modifying a communication from a first network component to a second network component by indicating a reason for a service change and/or by indicating a change of the service. Furthermore, a communication system is suggested containing this device.

The invention relates to a method and to a device for processing data in a network.

Deep Packet Inspection (DPI) is a form of computer network packet filtering that examines the data and/or header part of a packet as it passes an inspection point, searching for protocol non-compliance, viruses, spam, intrusions or predefined criteria to decide if the packet can pass or if it needs to be routed to a different destination, or for the purpose of collecting statistical information. Deep Packet Inspection (and filtering) enables advanced security functions as well as internet data mining, eavesdropping, and censorship.

A user surfing through the Internet may experience unavailability of a particular service, site or network component, e.g. server, wherein the user is not aware of any reason as why the service requested is not available or denied. A reason may be a broken server or a server that has been moved to a different site or link.

The problem to be solved is to overcome the disadvantage stated before and in particular to provide an efficient approach to let a user experience a reason for a denial of a request.

This problem is solved according to the features of the independent claims. Further embodiments result from the depending claims.

In order to overcome this problem, a method for processing data in a network is provided comprising the step:
(a1) a gateway modifies a communication from a first network component to a second network component by indicating a reason for a service change and/or by indicating a change of the service.

Hence, a user via a second network component (client device) requesting a service from the first network component or from the network in general is informed about the reason as why the service is changed, in particular that the service is no longer reachable from this first network component. In addition, the client device (second network component) can be informed about the change of the service, in particular it may obtain an information as how to access the service required from a different location.

Eventually, the client device (second network component) and thus the user may be able to access the requested service from the network component that actually provides such service. The gateway may in particular forward information that can be used to access the correct network component.

The service requested may comprise any kind of service that can be provided by the network, in particular by a component or resource of a network, in particular of the Internet. Such service may be, e.g., an information, a site, a page, a program, a link (URL) or any other kind of content information.

Advantageously, protocols of the first network component as well as of the second network component do not have to be amended or changed and the second network component (e.g., the client) may still become aware of a relocation of a service or content accessible, e.g., via a different server. This different server may be accessible by information provided by the gateway to the second network component (e.g., to the client).

According to an embodiment, the gateway performs deep packet inspection to determine whether or not modification of a communication, in particular redirection, is required.

Hence, the gateway may analyze IP packets by some sort of TCP flow tracking to determine whether or not an IP packet arriving at the gateway (from, e.g., a client) tries to access a service that matches a “denied rule”. Such “denied rule” may be locally available at the gateway or it may be accessible to the gateway to find out whether a particular access service matches a denied criteria. In such case, the gateway could start dropping IP packets that fall under such “denied rule” or it may initiate redirection or it may initiate a reset of a TCP connection between the first network component and the second network component.

According to another embodiment, the gateway performs layer-4 processing, in particular without using TCP level processing. In particular, the packets are inspected on layer-4 and also the TCP level payload can be read to obtain the payload data on HTTP level (e.g., HTTP methods and headers).

Hence, no resource demanding layer-7 processing is required at the gateway. The suggested layer-4 processing can be conducted, e.g., by a kernel of the gateway, which leads to a much faster overall performance handling messages at the gateway.

According to just another embodiment, the gateway modifies the communication if a request from the second network component to the first network component is directed to a denied service.

Redirection may in particular be required in case a prepaid user runs out of memory and the access needs to be redirected to a self-service portal that allows the user to use a credit card. Redirection may also become necessary if access is not allowed to a specific URL (service) and the operator wants to inform the client as why the service is not allowed (wrong time or wrong profile). In addition, redirection may be necessary if the service is denied temporarily, e.g., for maintenance needs. In addition, the service may have been moved to another server, which can be indicated to the client. Furthermore, a welcome page needed for the first service usage action can be provided by redirection means.

It is also an embodiment that the gateway initiates redirection and/or the gateway starts dropping data directed towards the first network component.

In an embodiment, the change of the service is indicated by conveying redirection information to access the service via a third network component.

Said redirection information may be a change of an address (e.g., URL) that can be utilized by a client (e.g., the second network component) to access the required data or information via a different network component (another server than the server previously addressed).

In another embodiment, the first network component is a first server, the second network component is a client and the third network component is a second server.

Other than that, the first, second and third network components can be any kind of components distributed throughout the network. Any of the network components may be a user's device or client or a server, e.g., operated by a service provider.

In a further embodiment, said communication from the first network component comprises a “Not found” message or an “OK message”, optionally comprising the redirection information to access the service via said third network component.

In a next embodiment, the solution provided comprises the step:
(a2) the second network component accesses the third network component utilizing said redirection information.

Such access may be processed via said gateway. Hence, the client device may get access to the information required via said third network component (e.g., additional server).

It is also an embodiment that the network comprises the Internet or is associated with the Internet.

Pursuant to another embodiment, said service comprises at least one of the following:
a service provided by the network being addressable in the network;
a site or a page of the network;
a content of the network;
an URL.

According to an embodiment, the solution provided comprises the following step prior to step (a1):
(a0) the gateway receives a request for the service from the second network component and changes this request into a message to be conveyed to the first network component, pursuant to which the first network component provides a response without a message body.

Such a message to be conveyed to the first network component may be a HEAD-message indicating that the first network component (server) must not return a message body in a response message. Only the HTTP headers are provided in such response and further conveyed to the second network component (the client), comprising e.g., a content-type, a content-size, a date.

For example, the first network component may just return a “method not allowed” or a “200 OK” message.

The response from the first network component can be modified by the gateway, e.g., by providing a service or a service-relevant information.

According to another embodiment, the gateway receives a message without a message body from the first network component in return to the HEAD-message.

In yet another embodiment, the solution provided comprises the following step prior to step (a1):
(a0) the gateway receives a request for the service from the second network component and changes this request into a GET-message, a PUT-message or a POST-message to be conveyed to the first network component.

According to a next embodiment, the gateway receives a “200 OK” message in return to the GET, PUT- or POST-message in particular indicating the change of the service within a message body.

The problem stated above is also solved by a device comprising a and/or being associated with a processor unit and/or a hard-wired circuit and/or a logic device that is arranged such that the method as described herein is executable thereon.

According to an embodiment, the device is a or is associated with a communication device, in particular a network component, a gateway, a server or a client device.

The problem stated supra is further solved by a communication system comprising the device as described herein.

Embodiments of the invention are shown and illustrated in the following figures:

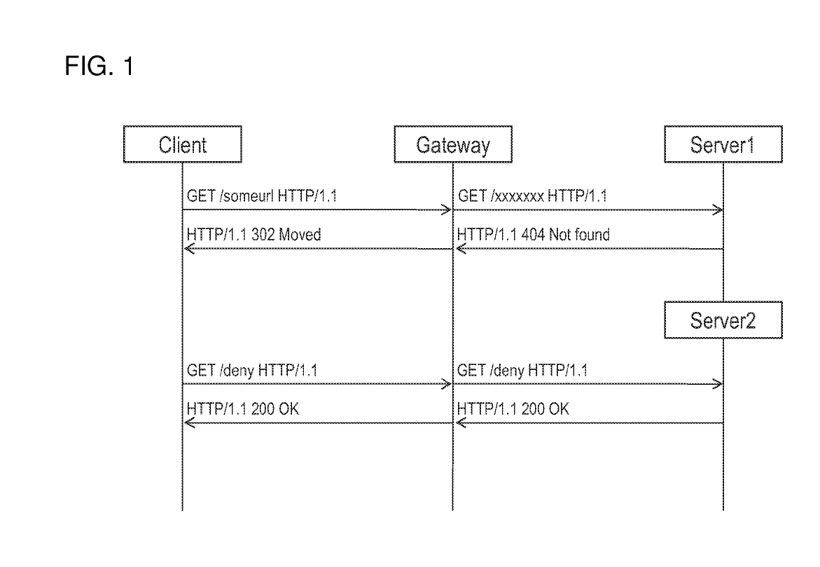

FIG. 1 shows an exemplary message sequence chart between a client, a gateway, a Server1 and a Server2, wherein a reason of a service change or a change of service, in particular a redirection information, is conveyed to the client device;

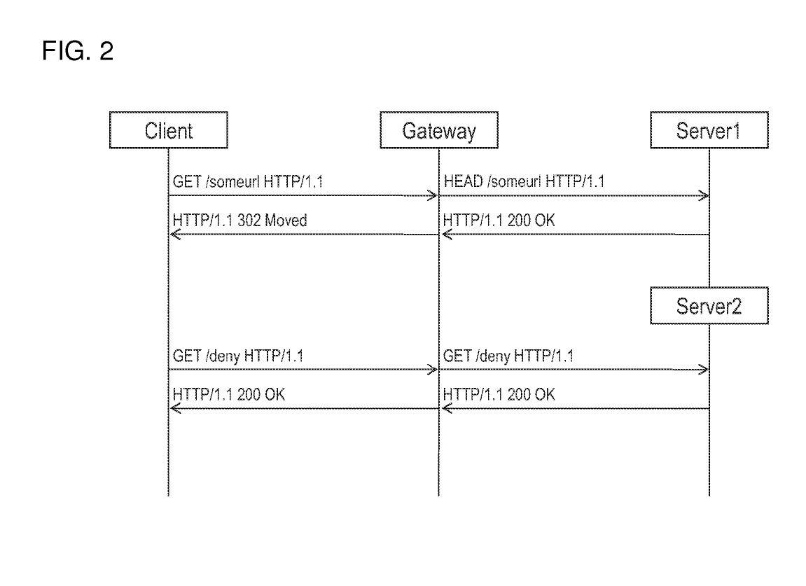

FIG. 2 shows an alternative message sequence chart between a client, a gateway, a Server1 and a Server2, wherein a reason of a service change or a change of service, in particular a redirection information, is conveyed to the client device;

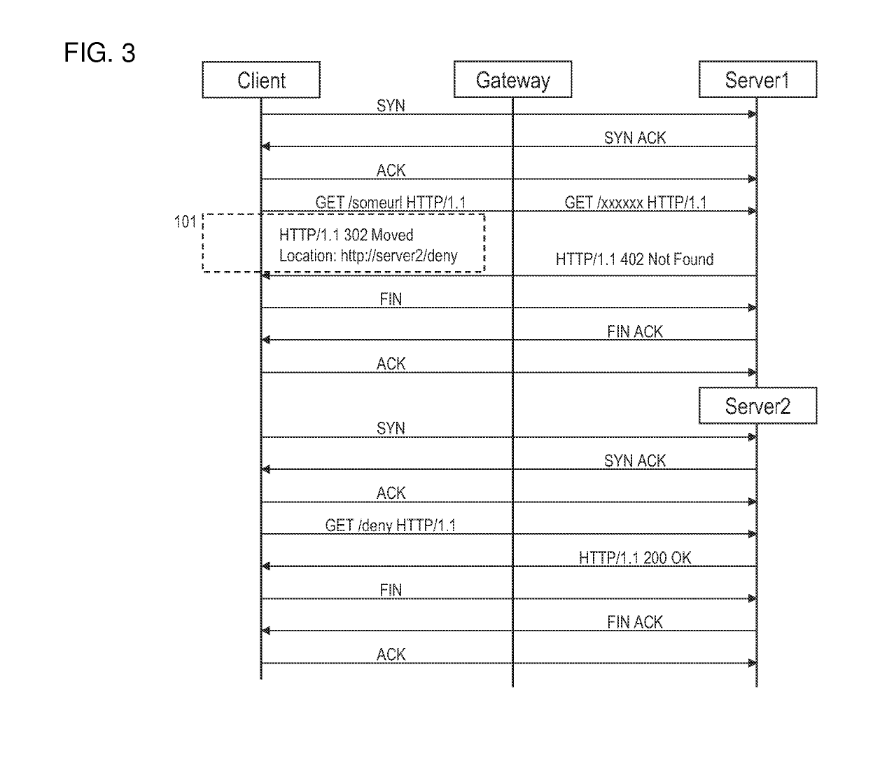

FIG. 3 shows a message sequence chart based on FIG. 1 in more detail.

The approach provided herein in particular enables an HTTP redirection transparently processed in an IP gateway that is analyzing the IP traffic, e.g., on layer-4 (L4).

For example, in case of a proxy mode deep packet inspection (DPI), TCP sessions are terminated in a gateway node so that a user space (on layer-7 (L7)) application in the gateway is able to process the HTTP requests and inspect the payload data. If the HTTP request is allowed to its final destination, the gateway will make the connection towards the destination server and it will send the original request to such destination server. If a response arrives from the server, the gateway sends the response to the client using the existing connection. In this kind of communication, if the access needs to be redirected, the gateway does not need to connect to the destination server at all. Instead, the gateway may immediately after having received the HTTP request from the client send the redirection response back to the client. However, such kind of direct processing bears the disadvantage of the proxy mode gateway requiring a lot of processing capacity, because the TCP session terminates at the gateway and it is processed by the gateway's user space application on L7 (i.e. L7 is required at such gateway). Hence, a TCP handshake is being processed between the client and gateway and also between the gateway and the server. So each connection from the client is processed locally in the gateway user space, which results in heavy operation (compared to mere L4 level processing).

For example, the network gateway being able to route IP packets in kernel level (L4) up to 1 GBits/s may only process about 100 MBit/s in user space (L7). TCP stream processing in application space requires IP packet reassembly, handling of the TCP window, sequence number processing, retransmissions, etc., which results in a lot of processing capacity all done by said gateway.

The approach provided herein allows for a gateway to operate, e.g., in a kernel mode DPI on layer-4 (L4). Such kernel mode DPI gateway may advantageously investigate IP packets having some sort of TCP flow tracking (e.g., state full inspection). The purpose of this kind of flow tracking may comprise denying service access that matches a so-called ‘deny’ rule. Hence, if the client connects to the HTTP service the TCP session is established between the client and the server (TCP handshake between the client and server). The DPI gateway located in the path between the client and the server may inspect, route and forward the IP packets. If the HTTP request arriving at the gateway does have the service access to a denied service, the gateway will start dropping the IP packets or it will send the TCP reset to the client and to the server for terminating the TCP session.

Hence, the approach described herein allows making a redirection in the kernel space (L4 of the gateway) without using TCP level processing. By providing redirection as described herein, the DPI gateway does not have to break the TCP connection between the server and client.

It is however noted, that prior to the client being able to send the request to the server via the gateway providing DPI services, the connection may have to be established, e.g., via TCP handshake. Hence, when the client sends the packet containing an HTTP request in a TCP payload which does match the deny/redirect rule, the gateway performs DPI and is thus able to provide redirection as described herein. If TCP retransmission is required, the server will be able to handle it—the DPI gateway may only rewrite the data as described herein.

An example could be summarized as follows:

In case redirection is done, the format of the headers may be as follows:
The client sends:
   GET/someurl HTTP/1.1
   Host: www.server1.com
   Accept: */*
   Connection: keep-alive
The server responds with:
   HTTP/1.1 302 Moved
   Location: http://www.server2.com/deny
   Content-length: 0
   Connection: close
Based on the server's response, the client can launch a new request:
   GET/deny HTTP/1.1
   Host: www.server2.com
   Accept: */*
   Connection: keep-alive

Also, a response code 301 may be applicable for most web browsers. Accordingly, the following redirection response from the server may work in a similar manner:
HTTP/1.1 301 Moved
Location: http://www.server2.com/deny
Content-length: 0
Connection: close

Hence, the IP gateway may modify an HTTP URL received via an IP packet to point to a nonexistent URL. The destination server may return an HTTP response “404 Not found”.

Such response is received at the IP gateway, which modifies it into a “302 Moved” message. In addition, the IP gateway modifies HTTP response headers to carry a ‘Location’ header comprising the redirection URL. After such changes, the TCP CRC is recalculated and the IP packet is sent to the HTTP client.

Hence, the client is able to send a HTTP GET request to another server utilizing the redirection URL conveyed by the IP gateway.

FIG. 1 shows an exemplary message sequence chart between a client, a gateway, a Server1 and a Server2.

The messages exchanged can be describes as follows:
(1) A connection between the client and the Server1 is established via the gateway. After a TCP three way handshake, the client sends a HTTP request comprising in particular GET/someurl HTTP/1.1
   Host: www.server1.com
   Accept: */*
   Connection: keep-alive
to the gateway. The gateway analyzes the incoming HTTP request, e.g., utilizing DPI to find out whether or not it matches the deny/redirect rule. In the affirmative, the gateway performs DPI and is thus able to provide redirection. If TCP retransmission is required, the server will be able to handle it—the DPI gateway just needs to rewrite the data. The gateway changes the destination URL, e.g., such that an TCP packet sequence number is not changed and forwards a message
   GET/xxxxxxx HTTP/1.1
   Host: www.server1.com
   Accept: */*
   Connection: keep-alive
to the Server1.
(2) Because the destination URL “/xxxxxxx” does not exist, the Server1 responds with a HTTP response
   HTTP/1.1 404 Not found.
   Content-length: 250
   Connection: keep-alive
The response code from the Server1 may also comprise or be “302”. Some HTTP services provide a missing service notification by redirecting the access to an own service from where the status can be retrieved.
The gateway modifies this response into
   HTTP/1.1 302 Moved
   Location: http://www.server2.com/deny
   Content-length: 0
   Connection: close
and replaces the HTTP headers to comprise a location information of a redirect URL “ . . . /deny”. For example, a information “http://www.server2.com/deny” could be provided to indicate that the content can be found via a redirection information “http://www.server2.com”.
Such modified data packet is forwarded from the gateway to the client.
(3) The client closes the existing TCP connection to the Server1 and establishes a new connection to the Server2. Furthermore, the client uses the redirect URL “ . . . /deny” via a GET request
   GET “ . . . /deny” HTTP/1.1.
   Host: www.server2.com
   Accept: */*
   Connection: keep-alive
The gateway forwards this request directly to the Server2.
(4) The Server2 responds with a message HTTP/1.1 200 OK
   Content-length: 500
   Connection: keep-alive
   <html><p>Your service is denied . . . </html>
and conveys the data requested to the client via the gateway. Said gateway just forwards the data to the client.

It is noted that the “ . . . /deny” expression can have different meaning. For example, a client may be configured to use a HTTP proxy, i.e. the client is connected via the gateway and further via said HTTP proxy to the Server2 (e.g., “www.server2.com”):
GET http://www.server2.com/deny HTTP/1.1.
Host: www.server2.com
Accept: */*
Connection: keep-alive

As an alternative, the client may not use such HTTP proxy, but have a direct connection to the destination (e.g., to Server2) via said gateway:
GET/deny HTTP/1.1.
Host: www.server2.com
Accept: */*
Connection: keep-alive

Both such formats may be adapted by changing the method line path accordingly. The location header may be the same for both, the direct mode and the proxy mode server redirection response (location according to the example: http://www.server2.com/deny.

FIG. 3 shows a message sequence chart based on FIG. 1 in more detail. Hence, TCP message flags SYN, SYN ACK, ACK, FIN, FIN ACK are shown indicating synchronization (SYN), acknowledgement (ACK) and an end of a connection (FIN).

A first connection is established between the client and the Server1 and a second connection is established between the client and the Server2 after the redirection response 101 has been provided to the client.

Hence, the redirection can be provided, e.g., by the kernel of the gateway without using any TCP level processing. This enables redirection without the gateway having to break up the TCP connection between the Server1 and the client.

It is noted that before the client is able to send a request to the Server1 via said DPI gateway, the connection needs to be established, i.e. via TCP handshake, comprising SYN, SYN ACK and ACK messages.

When the client sends a packet containing the HTTP request in TCP payload, which does match the deny/redirect rule, the DPI gateway is able to do the redirection as described. If the TCP retransmission is required due to such matching entry regarding said deny/redirect rule, the Server1 may handle it and the DPI gateway may just rewrite the data to be forwarded. Redirection status codes as indicated, e.g., 301 or 302, may both work for most web clients.

### ALTERNATIVE EMBODIMENT

As an alternative, the approach provided herein enables HTTP redirection transparently in the IP gateway that is analyzing the IP traffic by modifying the accessed HTTP method “HEAD” instead of methods “GET”, “PUT” or “POST” so that the destination server may return a HTTP response “200 OK” or any other valid HTTP response.

Such response, received by the IP gateway, is modified into a “302 Moved” message. In addition, the IP gateway also modifies the HTTP response headers to carry a ‘Location’ header having the redirection URL. After such changes, the TCP CRC is recalculated and the IP packet is sent to the HTTP client.

Hence, the client is able to send an HTTP GET request to another server utilizing the redirection URL conveyed by the IP gateway.

FIG. 2 shows a different embodiment visualized by a message sequence chart comprising a client, a gateway, a Server1 and a Server2.

The messages exchanged can be describes as follows:
(1) A connection between the client and the Server1 is established via the gateway. After a TCP three way handshake, the client sends a HTTP request
   GET/someurl HTTP/1.1
   Host: www.server1.com
   Accept: */*
   Connection: keep-alive
to the gateway. The gateway analyzes the incoming HTTP request and the gateway knows that the service accessed would be denied and that redirection is needed. The gateway changes the HTTP method to a “HEAD” message such that a TCP packet sequence number is not changed and forwards a message
   HEAD/someurl HTTP/1.1
   Host: www.server1.com
   Accept: */*
   Connection: keep-alive
to the Server1.
(2) The HEAD message is similar to the GET message except that the server's response does not provide a message-body.
The server responds with HTTP response
   HTTP/1.1 200 OK
   Content-length: 0
   Content-type: text/html
   Server: Apache/1.3
   Last-Modified: Sat, 29 Oct. 2007 19:43:31 GMT
   Connection: keep-alive
The gateway modifies this response into
   HTTP/1.1 302 Moved
   Location: http://www.server2.com/deny
   Content-length: 0
   Connection: close
and replaces the HTTP headers to comprise a location information of a redirect URL “ . . . /deny”. Such modified data packet is forwarded from the gateway to the client.
(3) The client closes the existing TCP connection to the Server1 and establishes a new connection to the Server2. Furthermore, the client uses the redirect URL “ . . . /deny” via a GET request
   GET “ . . . /deny” HTTP/1.1
   Host: www.server2.com
   Accept: */*
   Connection: keep-alive
The gateway forwards this request directly to the Server2.
(4) The Server2 responds with a message
   HTTP/1.1 200 OK
   Content-length: 500
   Connection: keep-alive
   <html><p>Your service is denied . . . </html>
and conveys the data requested to the client via the gateway. Said gateway just forwards the data to the client.

It is noted that the “ . . . /deny” expression can have different meaning as explained with regard to the example above. Hence, a client may be configured to use a HTTP proxy or it may utilize a direct connection.

### Further Advantages:

Hence, pursuant to the approach provided herein, TCP level packet retransmission is handled by the client and by the server, wherein the gateway does not have to modify any TCP sequence and/or acknowledge numbers. In particular, the gateway does not have to buffer IP packets which have not yet been acknowledged either by the client or by the server.

Usually the “404 Not found” response provided by the Server1 may not comprise any payload data to be sent to the client. However, the space in the IP packet that could otherwise be used for payload data could be utilized by conveying a redirection URL, in particular with additional data.

Also, HTTP servers and/or clients may send other HTTP headers ‘Server’ and ‘Content-Type’ which can be replaced to contain a redirection header with additional data. If IP packet retransmission occurs, the gateway needs only to rewrite the IP packet as it has done previously. The TCP/IP session information and/or termination are handled by the original client and by the server. The IP gateway may in particular only forward the TCP/IP signaling packets.

This is of advantage as this approach does not require the IP gateway to terminate all HTTP sessions transparently within its own TCP/IP stack or a partial implementation thereof.

1-18. (canceled)

19. A method for processing data in a network, which comprises the step of:
modifying, via a gateway, a communication from a first network component to a second network component by indicating at least one of a reason for a service change or by indicating a change of a service.

20. The method according to claim 19, which further comprises performing, via the gateway, a deep packet inspection to determine if a modification of the communication is required.

21. The method according to claim 20, which further comprises performing, via the gateway, layer-4 processing.

22. The method according to claim 19, which further comprises using the gateway to modify the communication if a request from the second network component to the first network component is directed to a denied service.

23. The method according to claim 20, which further comprises performing at least one of:
initiating a redirection via the gateway; or
using the gateway to start dropping the data directed towards the first network component.

24. The method according to claim 19, which further comprises indicating the change of the service by conveying redirection information to access the service via a third network component.

25. The method according to claim 24, wherein the first network component is a first server, the second network component is a client and the third network component is a second server.

26. The method according to claim 25, wherein the communication from the first network component comprises a “Not found” message or an “OK message”, and the redirection information to access the service via the third network component.

27. The method according to claim 19, wherein the second network component accesses a third network component utilizing redirection information.

28. The method according to claim 19, wherein the network comprises an Internet or is associated with the Internet.

29. The method according to claim 19, wherein the service comprises at least one of the following:
a service provided by the network being addressable in the network;
a site or a page of the network;
a content of the network; and
an URL.

30. The method according to claim 19, wherein prior to performing the modifying step, receiving, via the gateway, a request for the service from the second network component and changing the request into a message to be conveyed to the first network component, pursuant to which the first network component provides a response without a message body.

31. The method according to claim 30, wherein the gateway receives a message without the message body from the first network component in return to a HEAD-message.

32. The method according to claim 19, wherein prior to performing the modifying step, receiving, via the gateway, a request for the service from the second network component and changing the request into a GET-message, a PUT-message or a POST-message to be conveyed to the first network component.

33. The method according to claim 32, wherein the gateway receives a “200 OK” message in return to the GET-message, the PUT-message or the POST-message from the first network component indicating the change of the service within a message body.

34. The method according to claim 19, which further comprises performing, via the gateway, a deep packet inspection to determine if a redirection of the communication is required.

35. The method according to claim 20, which further comprises performing, via the gateway, layer-4 processing without using TCP level processing.

36. The method according to claim 22, which further comprises indicating the change of the service by conveying redirection information to access the service via a third network component.

37. The method according to claim 24, wherein the communication from the first network component comprises a “Not found” message or an “OK message”, and the redirection information to access the service via the third network component.

38. The method according to claim 22, wherein the second network component accesses a third network component utilizing redirection information.

39. The method according to claim 24, wherein the second network component accesses the third network component utilizing the redirection information.

40. The method according to claim 25, wherein the second network component accesses the third network component utilizing the redirection information.

41. The method according to claim 26, wherein the second network component accesses the third network component utilizing the redirection information.

42. The method according to claim 22, wherein the network comprises an Internet or is associated with the Internet.

43. The method according to claim 24, wherein the network comprises an Internet or is associated with the Internet.

44. The method according to claim 25, wherein the network comprises an Internet or is associated with the Internet.

45. The method according to claim 26, wherein the network comprises an Internet or is associated with the Internet.

46. The method according to claim 27, wherein the network comprises an Internet or is associated with the Internet.

47. The method according to claim 22, wherein the service comprises at least one of the following:
a service provided by the network being addressable in the network;
a site or a page of the network;
a content of the network; and
an URL.

48. The method according to claim 24, wherein the service comprises at least one of the following:
a service provided by the network being addressable in the network;
a site or a page of the network;
a content of the network; and
an URL.

49. The method according to claim 25, wherein the service comprises at least one of the following:
a service provided by the network being addressable in the network;
a site or a page of the network;
a content of the network; and
an URL.

50. The method according to claim 26, wherein the service comprises at least one of the following:
a service provided by the network being addressable in the network;
a site or a page of the network;
a content of the network; and
an URL.

51. The method according to claim 27, wherein the service comprises at least one of the following:
a service provided by the network being addressable in the network;
a site or a page of the network;
a content of the network; and
an URL.

52. The method according to claim 28, wherein the service comprises at least one of the following:
a service provided by the network being addressable in the network;
a site or a page of the network;
a content of the network; and
an URL.

53. The method according to claim 22, wherein prior to performing the modifying step, receiving, via the gateway, a request for the service from the second network component and changing the request into a message to be conveyed to the first network component, pursuant to which the first network component provides a response without a message body.

54. The method according to claim 24, wherein prior to performing the modifying step, receiving, via the gateway, a request for the service from the second network component and changing the request into a message to be conveyed to the first network component, pursuant to which the first network component provides a response without a message body.

55. The method according to claim 25, wherein prior to performing the modifying step, receiving, via the gateway, a request for the service from the second network component and changing the request into a message to be conveyed to the first network component, pursuant to which the first network component provides a response without a message body.

56. The method according to claim 26, wherein prior to performing the modifying step, receiving, via the gateway, a request for the service from the second network component and changing the request into a message to be conveyed to the first network component, pursuant to which the first network component provides a response without a message body.

57. The method according to claim 27, wherein prior to performing the modifying step, receiving, via the gateway, a request for the service from the second network component and changing the request into a message to be conveyed to the first network component, pursuant to which the first network component provides a response without a message body.

58. The method according to claim 28, wherein prior to performing the modifying step, receiving, via the gateway, a request for the service from the second network component and changing the request into a message to be conveyed to the first network component, pursuant to which the first network component provides a response without a message body.

59. The method according to claim 29, wherein prior to performing the modifying step, receiving, via the gateway, a request for the service from the second network component and changing the request into a message to be conveyed to the first network component, pursuant to which the first network component provides a response without a message body.

60. The method according to claim 53, wherein the gateway receives a message without the message body from the first network component in return to a HEAD-message.

61. The method according to claim 54, wherein the gateway receives a message without the message body from the first network component in return to a HEAD-message.

62. The method according to claim 55, wherein the gateway receives a message without the message body from the first network component in return to a HEAD-message.

63. The method according to claim 56, wherein the gateway receives a message without the message body from the first network component in return to a HEAD-message.

64. The method according to claim 57, wherein the gateway receives a message without the message body from the first network component in return to a HEAD-message.

65. The method according to claim 58, wherein the gateway receives a message without the message body from the first network component in return to a HEAD-message.

66. The method according to claim 59, wherein the gateway receives a message without the message body from the first network component in return to a HEAD-message.

67. The method according to claim 22, wherein prior to performing the modifying step, receiving, via the gateway, a request for the service from the second network component and changing the request into a GET-message, a PUT-message or a POST-message to be conveyed to the first network component.

68. The method according to claim 24, wherein prior to performing the modifying step, receiving, via the gateway, a request for the service from the second network component and changing the request into a GET-message, a PUT-message or a POST-message to be conveyed to the first network component.

69. The method according to claim 25, wherein prior to performing the modifying step, receiving, via the gateway, a request for the service from the second network component and changing the request into a GET-message, a PUT-message or a POST-message to be conveyed to the first network component.

70. The method according to claim 26, wherein prior to performing the modifying step, receiving, via the gateway, a request for the service from the second network component and changing the request into a GET-message, a PUT-message or a POST-message to be conveyed to the first network component.

71. The method according to claim 27, wherein prior to performing the modifying step, receiving, via the gateway, a request for the service from the second network component and changing the request into a GET-message, a PUT-message or a POST-message to be conveyed to the first network component.

72. The method according to claim 28, wherein prior to performing the modifying step, receiving, via the gateway, a request for the service from the second network component and changing the request into a GET-message, a PUT-message or a POST-message to be conveyed to the first network component.

73. The method according to claim 29, wherein prior to performing the modifying step, receiving, via the gateway, a request for the service from the second network component and changing the request into a GET-message, a PUT-message or a POST-message to be conveyed to the first network component.

74. The method according to claim 67, wherein the gateway receives a “200 OK” message in return to the GET-message, the PUT-message or the POST-message from the first network component indicating the change of the service within a message body.

75. The method according to claim 68, wherein the gateway receives a “200 OK” message in return to the GET-message, the PUT-message or the POST-message from the first network component indicating the change of the service within a message body.

76. The method according to claim 69, wherein the gateway receives a “200 OK” message in return to the GET-message, the PUT-message or the POST-message from the first network component indicating the change of the service within a message body.

77. The method according to claim 70, wherein the gateway receives a “200 OK” message in return to the GET-message, the PUT-message or the POST-message from the first network component indicating the change of the service within a message body.

78. The method according to claim 71, wherein the gateway receives a “200 OK” message in return to the GET-message, the PUT-message or the POST-message from the first network component indicating the change of the service within a message body.

79. The method according to claim 72, wherein the gateway receives a “200 OK” message in return to the GET-message, the PUT-message or the POST-message from the first network component indicating the change of the service within a message body.

80. The method according to claim 73, wherein the gateway receives a “200 OK” message in return to the GET-message, the PUT-message or the POST-message from the first network component indicating the change of the service within a message body.

81. The method according to claim 36, wherein the first network component is a first server, the second network component is a client and the third network component is a second server.

82. The method according to claim 81, wherein the communication from the first network component comprises a “Not found” message or an “OK message”, and the redirection information to access the service via the third network component.

83. The method according to claim 82, wherein the second network component accesses the third network component utilizing the redirection information.

84. The method according to claim 83, wherein the network comprises an Internet or is associated with the Internet.

85. The method according to claim 84, wherein the service comprises at least one of the following:
a service provided by the network being addressable in the network;
a site or a page of the network;
a content of the network; and
an URL.

86. The method according to claim 85, wherein prior to performing the modifying step, receiving, via the gateway, a request for the service from the second network component and changing the request into a message to be conveyed to the first network component, pursuant to which the first network component provides a response without a message body.

87. A device, comprising:
at least one apparatus selected from the group consisting of a processor unit, a device associated with a processor unit, a hard-wired circuit, and a logic device, said at least one apparatus programmed to:
modify, via a gateway, a communication from a first network component to a second network component by indicating at least one of a reason for a service change or by indicating a change of a service.

88. The device according to claim 87, wherein said apparatus is a network component.

89. The device according to claim 87, wherein said apparatus is selected from the group consisting of said gateway and a server of a client device.

90. The device according to claim 87, wherein the device associated with a network component.

91. A communication system, comprising:
at least one apparatus selected from the group consisting of a processor unit, a device associated with a processor unit, a hard-wired circuit, and a logic device, said at least one apparatus programmed to:
modify, via a gateway, a communication from a first network component to a second network component by indicating at least one of a reason for a service change or by indicating a change of a service.

92. The communication system according to claim 91, wherein said apparatus is a network component.

93. The communication system according to claim 91, wherein said apparatus is selected from the group consisting of said gateway and a server of a client device.

94. The communication system according to claim 91, wherein said apparatus is associated with a network component.
